(19) United States
(12) Patent Application Publication
(10) Pub. No.: US 2011/0085040 A1
(43) Pub. Date: Apr. 14, 2011

(54) ELECTRICALLY POWERED PLAYGROUND EQUIPMENT

(75) Inventors: Robert C. Joslyn, Nixa, MO (US); Kathleen A. Geyer, Pierce City, MO (US); J. Stephen Steury, Rogersville, MO (US); Michael A. Sutton, Grove City, PA (US); Dan Guthrie, Mooresville, NC (US)

(73) Assignee: MIRACLE RECREATION EQUIPMENT COMPANY, Monett, MO (US)

(21) Appl. No.: 12/902,879

(22) Filed: Oct. 12, 2010

Related U.S. Application Data
(60) Provisional application No. 61/250,646, filed on Oct. 12, 2009.

(51) Int. Cl. H04N 7/18

(52) U.S. Cl. 348/157; 348/E07.085

(57) ABSTRACT

A playground security system comprises a power supply and a monitoring station. The monitoring station comprises a camera, a light and/or an audio deterrent device which are electrically connected to the power supply. The monitoring station can be contained in a post; and the post is part of a playground structure or can be a stand alone post. The audio deterrent device emits signals in a frequency range that is bothersome to humans between the ages of about 13 to about 25 years. The audio deterrent device and light are activated by a motion sensor. Further, the system includes a dusk-to-dawn sensor which also controls the audio deterrent device and the light. The camera can be in an “always-on” mode and can be adapted to transmit signals containing visual or audio-visual information. The camera signals can be stored and viewed remotely from the playground.

### CROSS-REFERENCE TO RELATED APPLICATIONS

This application claims priority to U.S. Provisional Application No. 61/250,646, which was filed on Oct. 12, 2009, entitled “Electrically Powered Playground Equipment”, and which is incorporated herein by reference.

### STATEMENT REGARDING FEDERALLY SPONSORED RESEARCH OR DEVELOPMENT

Not Applicable.

### BACKGROUND OF THE INVENTION

This invention relates generally to playground equipment, and in particular, to electrically powered playground security equipment which will help monitor playgrounds and deter loitering.

Playgrounds are generally considered safe places for children to play. However, older children and teens often congregate on playgrounds after hours (i.e., after dusk) and can make a significant amount of noise. This noise can be bothersome to those who live in close proximity to the playground. Further, some vandalize playgrounds. They either paint the playground equipment with graffiti, set the playground equipment on fire, steal components, or otherwise mar the playground equipment. As can be appreciated, if equipment is damaged, the equipment will need to be repaired or replaced, and if it is painted with graffiti, it will need to be cleaned. These are both financial burdens that the playground owner does not want to bear.

Further, many would like to be able to visually monitor playgrounds. This can provide security during the dusk-to-dawn hours when vandals may attempt to mar the playground equipment. It can also provide security during the daylight hours, in the event that child predators or abductors should attempt to abduct a child from a playground.

### SUMMARY

A playground security system made in conformance with the claimed invention comprising a power supply and a monitoring station. The monitoring station comprises a camera, a light assembly and an audio deterrent device which are electrically connected to the power supply. The elements of the monitoring station can be housed together in a single housing (such as a post) or the elements can be separated from each other. In a preferred embodiment, the camera and audio deterrent device are housed together in a primary housing and the light assembly is in a separate, secondary housing. The camera is adapted to transmit signals containing visual or audio-visual information. The monitoring station can be contained in a post; and the post is part of a playground structure or can be a stand alone post.

The power supply can include a timer (which can be a dawn-to-dusk sensor), a first circuit, and a second circuit. The first circuit is connected to, or includes, the timer such that the first circuit is controlled by the timer, and at least one of the components of the monitoring station is in electrical communication with the first circuit to be controlled by the timer. Preferably, the light and the audio deterrent device are in electrical communication with the first circuit and the camera is in communication with the second circuit. Hence, the camera can be in an “always-on” mode, while the light and audio deterrent device are only activated when the timer activates the first circuit.

The security system can be adapted to transmit the camera signal to a location remote from the playground in which the security system is installed for viewing and/or storage. For example, the camera signals are transmitted wirelessly to the remote location for viewing. The signals can be stored on site (i.e., the security system can include a storage means) or the signals can be stored at the remote location. In order to transmit wirelessly, an IP address is assigned to the camera , and the camera signals can be transmitted over the internet.

The audio deterrent device comprises a sound generator which can emit a high frequency modulated tone in the range of about 17.5 kHz-about 18.5 kHz or a lower frequency tone at about 8 kHz. The tones are emitted at a sound level of about 84-99 db. The high frequency tone is bothersome to people between the age of about 13 and the age of about 25. The lower frequency tone is bothersome to people of all ages.

The monitoring station can include a motion detector positioned between the power supply and one or both of the light and the audio deterrent device. The motion detector is operable to activate the light and the audio deterrent device upon sensing motion.

In one embodiment, the playground security system can include a plurality of the monitoring stations distributed around a playground. In this instance, the monitoring stations can be configured to define sets of the monitoring stations. The monitoring stations within a set of monitoring stations can be interconnected and in communication with each other, such that when motion is sensed by the motion sensor of one monitoring station, at least one component (such as the lights) of the remaining monitoring stations in the set of monitoring stations are activated.

As noted, the monitoring station of the playground security system comprises a camera, a light assembly and an audio deterrent device. The camera is contained within a primary housing, which may also contain the audio deterrent device and/or the light. The light assembly can be contained in a secondary housing separate from the primary housing. In this instance, the primary housing contains the camera and the audio deterrent device. In other embodiments, all three components can be in separate housings; or the components can be grouped in other desired ways.

Additionally, the camera housing contains a conditioning circuit comprising thermostat, a heater and a fan. The thermostat activates the heater if the ambient temperature falls below a predetermined temperature and activates the fan if the ambient temperature exceeds a predetermined temperature. The camera housing includes a vent which places the interior of the housing in communication with the exterior of the housing. Preferably, the vent comprises an upper vent positioned vertically above the highest device in the hosing and a lower vent positioned below the lowest device in the housing. The fan is adapted to circulate air within the housing by drawing air in through one of the upper and lower vents and expelling air out of the other of the upper and lower vents.

### BRIEF DESCRIPTION OF THE SEVERAL VIEWS OF THE DRAWINGS

FIG. 1A is a perspective view of a one-piece or unitary monitoring station for a playground security system, the monitoring station including a camera, an audio deterrent device and lights;

FIG. 1B is a perspective view of an alternative embodiment of the unitary monitoring station;

FIG. 1C is a vertical cross-sectional view of the unitary monitoring station of FIG. 1B;

FIG. 1D is a perspective view of a light post of the playground security system;

FIG. 2 is an illustrative schematic of the monitoring station of the playground security system and an associated power supply for the security system as well as a power source, to facilitate explanation of the operation of the electrically powered playground equipment; and

FIG. 3 is an illustrative schematic of a playground area with a security system installed, the security system shown to comprise a plurality of monitoring stations dispersed around the playground structure.

Corresponding reference numerals will be used throughout the several figures of the drawings.

### DETAILED DESCRIPTION OF THE INVENTION

The following detailed description illustrates the claimed invention by way of example and not by way of limitation. This description will clearly enable one skilled in the art to make and use the claimed invention, and describes several embodiments, adaptations, variations, alternatives and uses of the invention, including what we presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

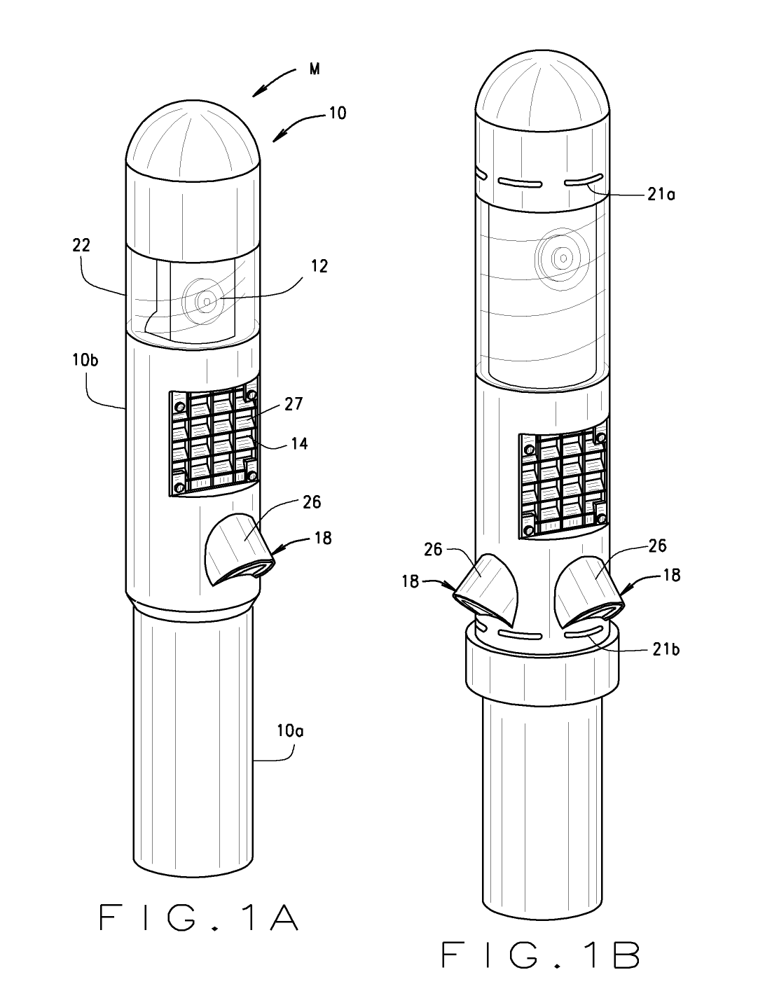

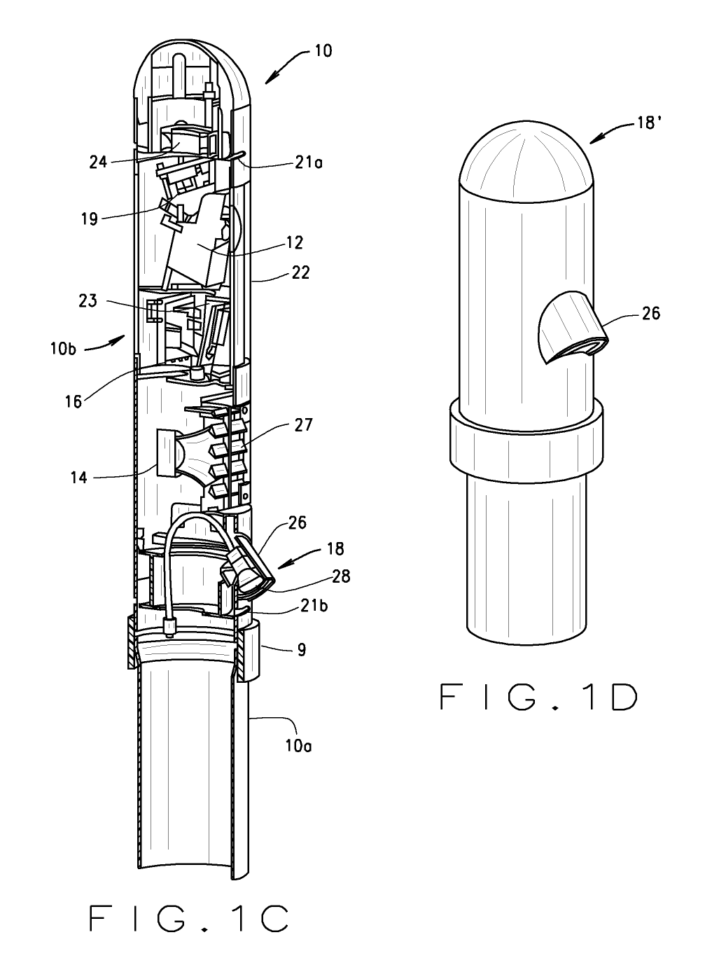

Referring initially to FIG. 3, a playground area P includes at least one play structure S, The play structure S is shown in top plan. The play structure can include any number of play elements, such as platforms, bridges, climbers, slides, etc. Additionally, the playground P can include additional modular or standalone play structure. The playground is provided with a security system 5. comprised of a power supply 20 and one or more monitoring stations M. Illustrative unitary monitoring stations M and M′ are shown in FIGS. 1A and 1B.

With reference to FIG. 3, a plurality of monitoring systems M are dispersed around the playground. The number and positioning of monitoring stations is shown purely for illustrative purposes. In an actual installment, the number and position of monitoring stations will be determined by the layout of the playground equipment. It will be understood, as explained above, that the monitoring system can be contained in stand-along posts, or be incorporated into the playground structure S itself. If a playground is small enough, one monitoring station M may be sufficient. Larger playgrounds or playground systems may require more than one monitoring station.

As illustratively shown in FIGS. 1A,B, the unitary monitoring station M is contained within a playground post 10. The post 10 is shown as a stand-alone post such as may be positioned at a periphery of the playground. Alternatively, the post can be a support post, which supports a play system (which commonly includes platforms, slides, climbers, etc.) Thus, the post 10 containing the security system can be incorporated into a playground structure. In this instance, the security system-containing post could be positioned near, or at, the top of the playground structure, near or at the bottom of the playground structure, or part way along the height of the playground structure. By way of example, play systems are sold by Miracle Recreation Equipment Company of Monett, Mo. under the names Mega Tower, Center Stage, and Kids Choice. The post 10 is hollow and as shown includes a lower section 10a and an upper section 10b, the upper section being of smaller diameter than the lower section. The post upper section 10b can be formed, for example, by swaging or necking the tube defining the post down to a smaller diameter. This is best seen in FIG. 10. As seen in FIG. 1C, a skirt 9 surrounds junction between the upper and lower post sections. The skirt 9 forms a seal at the junction to prevent water, dust and other debris from entering the post 10. Although shown with the upper post being of a larger diameter than the lower post, the dual-diameter post could, alternatively, be formed by joining two post sections of different diameter. The post 10, however, could be of a constant diameter.

Each monitoring station includes a camera 12, an audio deterrent device 14, a motion sensor or detector 16, and one or more light assemblies 18. In the unitary monitoring station, all three elements are contained in the post upper portion 10b, which defines a housing for the elements.

If FIGS. 1A-C, the monitoring station is shown as a unitary monitoring station in which the camera, light, and audio deterrent device are all contained in a single housing (i.e., the upper post 10b). A monitoring station could alternatively be a multi-part monitoring station in which one or more components of the monitoring station are separated from the other components of the monitoring station. In FIG. 1D, a separate light post 18′ is shown. In this instance, the camera 12 and audio deterrent device 14 can be combined together and are contained in a primary housing and the light assembly is contained in a separate, secondary housing. Alternatively, the camera 12 and audio deterrent device 14 can be separated from each other (such that the monitoring station is comprised of 3 units). In one embodiment, the monitoring station can comprise a primary housing or unit which houses the camera 12 and audio deterrent device 14 and a plurality of separate light units 18′. In this instance, the conditioning circuit can be provided with the primary unit housing the camera and audio deterrent device. This monitoring unit can include, for example, four separate light units. However, more or fewer light units could be provided. In an alternative, a monitoring station can comprise one a unitary monitoring station M,M′ along with a plurality of separate light units 18′. This would provide for a light with the camera and audio deterrent device, as well as lights farther from the camera and audio deterrent device. Depending on the camera used, having the light in the same housing as the camera can provide too much light close to the camera, which could adversely impact the image captured by the camera. In this instance, it would be preferred that the lights be contained in housing separate from camera.

Although the monitoring station preferably includes all three components (i.e., the camera, audio deterrent device and the light assembly) a monitoring station could be provided with a subset of the three components. Thus, the playground could have some monitoring stations which include all three components and other monitoring stations which include only one or two of the three components. For example, if a playground has multiple monitoring stations, it may not be necessary that all the monitoring stations have audio deterrent devices. This would require that the monitoring stations be in communication with each other.

The components devices are powered by a power supply 20 which receives power from a power source 22. The power supply is described in more detail below. The power source can be an electrical utility company, in which case, the power supply 20 is electrically connected to either an underground or overhead power line. Alternative sources of power, such as battery, solar or generated power can also be used. Generated power can be generated in most any fashion, and can include, for example, wind generated power and water generated power. Generated power can also be generated through operation of playground equipment—that is, for example, a playground “marry-go-round” can, for example turn a generator when spun, and the generator, in turn, can charge batteries. Further, the main power source could be an alternative power source which is then backed up by power from the electrical utility company if and when the alternative power source cannot produce enough energy for the playground components.

The camera 12 is mounted internally of the post 10, and the post includes a clear wall section or window 22 which exposes the camera lens. The motion detector 16 is positioned below the camera, so that its “eye” “sees” through the window 22. As can be appreciated, the window 22 protects the lens from the elements and vandalism. The window 22 preferably defines a complete cylinder. The camera can be mounted on a post which rotates within the post 10. This inner post could be driven by a motor to allow for the camera 12 to rotate relative to the post 10, such that the camera would have a 360° view of the area in which the post 10 is mounted. By controlling the motor, (for example by wireless or wired control) the field of view of the camera can be selectively changed. By rotating the camera, the camera 12 could have an effective field of view of 360°.

As can be appreciated, the security system will be located outside and will be exposed to large shifts in temperature and humidity throughout the year. The electronics of the security system can be affected by the temperature and humidity. With reference to FIGS. 1B and 1C, the post upper section or housing 10b can be provided with upper and lower vents 21a,b which allow the interior of the post to communicate with the exterior atmosphere. Preferably, the upper vents 21a are above the highest device in the housing and the lower vents 21b are below the lowest device in the housing. Internally, the post upper portion or housing 10b is provided with conditioning circuit comprised of a thermostatic switch 19, a fan 24 and a heater 23. The heater can be a radiant heater. The thermostatic switch is electrically connected to the fan and the heater to activate and deactivate the fan and heater. The heater will be activated when the thermostat detects that the temperature has fallen below a predetermined minimum (such as 32° F.). The fan will be activated when the thermostat detects that the temperature has risen above a predetermined maximum (such as 100° F.). The heater 23 is shown to be positioned below the camera 12 and motion sensor 16; such that the heat from the heater will radiate upwards to warm the camera and motion sensor in cold weather. The sound generator 14 and light 18 are less susceptible to cold temperatures, and do not need to be heated quite as directly. The fan 24 is positioned at the top of the post upper portion 10b, and in fact, above the upper vent 21a. When the fan is activated, the fan will draw air up from the lower vents 21b to expel the air out the upper vents 21a. This will provide cooling for the electrical components contained within the housing 10b. Additionally, it will serve to maintain a humidity level within the housing that is substantially equal to the humidity level outside of the housing. This may help reduce condensation from forming on the window 22 and on the electrical components contained in the housing 10b.

The camera 12 preferably is a wireless IP camera which can transmit signals over a wireless connection to the internet. The camera 12 can have its own IP address, and hence, by connecting to the IP address, the images transmitted by the camera 12 can be viewed and/or recorded/stored at a location remote from the playground. In a system, such as shown in FIG. 3, wherein there are a plurality of monitoring stations M (and hence a plurality of cameras), each camera can have its own IP address, or the signals from the cameras in the security system can be agglomerated to produce a single feed, and this single feed could then be transmitted. In this second instance, the security system as a whole could be assigned an IP address to access the feed from each of the cameras at a single IP address. A wireless internet camera, such as is available from Trendnet of Torrance, Calif. under product number TV-IP312W, will be acceptable. The camera is capable of transmitting real-time high quality video over the Internet which can be viewed or stored from any internet connection. The camera has a relatively wide viewing angle (i.e., about 60°) and can “see” in relatively dim light. The noted camera has a minimum illumination of 0.5 Lux. Additionally, the camera has infrared capabilities to enhance the camera's ability to record in the dark. The camera also has a microphone or other sound pick-up device so that the camera can record and transmit audio signals as well as video signals. The camera can be operated with 5V DC and consumes 8-10 watts of power. Additionally, it is operable over a broad temperature range (0° C.˜45° C. (32° F.˜113° F.)). Finally, the camera is always on—that is, it will continuously transmit images. However, it does not always record images. Rather, the camera includes its own motion detector; and, when the camera motion detector detects movement, the camera signals that the images should be recorded. If desired, the camera could be operated such that it is always recording or transmitting images. Alternatively, the camera can be controlled such that its recording/transmitting function is scheduled (i.e., activated between predetermined time periods) or selectively activated and deactivated (i.e., activated by motion detectors). The images can be recorded on a memory device that is internal to the camera, is contained within the post 10, or is remote from the playground.

Alternatively, the video or audio/video captured by the camera 12 can be relayed to a base station (which could include the power supply). The relay of the signals from the camera 12 to the base station can be accomplished via a wired or wireless transmission. This base station could include electronic storage media which would store the camera's video or audio/visual image. Such electronic storage media can include, for example, a magnetic disk drives, optical drives or memory boards (such as RAM, ROM, flash memory, etc.). The base station could also include a transmitter which transmits the video/audio-video signal to a remote location for viewing and/or storing. In this instance, the signals are stored on site, and transmitted to a remote location for viewing. The signals can be stored at the remote location as well, to provide for a backup of the signals stored on site. The transmission from the base station to the remote location can be a wired transmission (which is transmitted over appropriate cabling, or can be transmitted wirelessly. Both wired and wireless transmissions can be transmitted by way of the internet. If the base station includes a storage device and a transmitter, the base station will also include a receiver which receives the signals from the camera and a controller. The controller will control the storage device and the transmitter.

The camera can capture only images, or the camera can be equipped with a microphone to capture both images and audio. If the camera captures/records both images and sound (i.e., audio and visual), the signal from the camera will contain both audio and visual content.

The audio deterrent device 14 is mounted within the post 10, and has a sound generator or speaker that is exposed through an opening 25 in the post. As shown, the speaker of the audio device 14 is positioned behind a protective member 27 to protect the audio device from vandalism. This protective member 27 is shown to be a screen-like element. The audio deterrent device 14 can be operated in two modes. In one mode, it emits a high frequency modulated tone in the range of about 17.5 kHz-about 18.5 kHz and in a second mode, it emits a tone at a lower frequency of about 8 kHz. The tone is emitted at a sound level of about 84-99 db. It has been found that this high frequency range is bothersome to people between about 13-25 years old. The majority of people over about 25 years of age have lost the ability to hear at this frequency range, and this frequency range generally does not bother younger children or animals (such as pets). The lower frequency tone can be heard by everyone. An example of such an audio deterrent device is the Mosquito® MK4 anti-loitering device developed by Compound Security Systems, Ltd of Wales, UK, and which is available in the United States from Mosquito USA or Mosquito Group. The Mosquito anti-loitering device is also described in US Pub. No. 2007/0037691, which is incorporated herein by reference. The audio deterrent device can operate on 15V AC or 24V DC and a current of less than 500 ma and consumes about 6 watts of power. When activated, it transmits its sound for a determined period of time, and then automatically shuts off. It has an operational range of 40-60 m (i.e., ˜103 to ˜197 feet) in a 60° cone. Further, the audio device is weather resistant (has an operational range of about −20° C. to about 70° C. (about −4° F. to about 158° F.).

The light assemblies 18 extend outwardly and downwardly from the post 10. Two light assemblies 18 are shown in FIG. 1 B. However, more or fewer light assemblies could be used as desired. Additionally, as noted above, the monitoring station can comprise independent light assemblies or units 18′. The light assemblies 18,18′ each comprise a housing 26 which is generally tubular and extends outwardly and downwardly from the post 10, as seen. At least one light emitting device 28 (FIG. 1C) is mounted in the housing 26. Although not shown, the housing 26 contains an appropriate base which will receive the light emitting device 28. The light emitting device 28 can be any type of light emitting device (i.e., incandescent bulb, LED, fluorescent, halogen, high pressure sodium, etc). However, the light emitting device should be a long life—lower power consumption light emitting device. Additionally, the light emitting device should not generate much heat so that the housing 26 will not become too hot to the touch when the light emitting device 28 is on. A light emitting device such as an LED light available from Super Bright LED's of St. Louis, Mo., USA under product number SB MR11LED is acceptable. This light emitting device has an output of 77 lumens, uses 2 watts of power and has an expected life of up to 50,000 hours.

The cameras 12 operate on a 12V circuit. The light assemblies 18, the audio deterrent device 14 and the motion sensor 16, on the other hand, operate on a 24V circuit. Thus, the power supply 20 has a 12V circuit and a 24V circuit. Appropriate circuitry 30a,b (such as a transformer) is provided in the power supply 20 to step the line voltage down to 12V and 24V, respectively for the two circuits. Additionally, the power supplied to the electrical components is DC. Hence, the power supply 20 contains appropriate AC-DC converters 32 to convert the line current from AC to DC, if necessary. Finally, the power supply can be provided with a timer positioned between the 24V circuit and the power source. The timer 34 can be a dusk-to-dawn sensor or a programmable timer. If the time is a dusk-to-dawn sensor, the 24V circuit receives power only during the dusk-to-dawn hours, or more correctly, when it is determined by the dusk-to-dawn sensor to be dark. If the timer is a programmable timer, the timer activates the 24V circuit during selected programmed times.

To power the monitoring station equipment within the posts 10, electrical cables are run from the power supply 20 to the posts 10 containing the monitoring station electrical equipment. The cables are buried below the playground surfacing.

The camera 12 is on the 12V circuit. The dusk-to-dawn sensor is not positioned before the 12V circuit, and hence, the 12V circuit is “always on”. Hence, the camera receives power all day long (i.e., 24 hours a day). As noted above, the camera wirelessly preferably transmits its signals through the internet to be received by an appropriate internet connection where the images can be viewed or stored. If a WiFi network is available, the camera can transmit its images over the pre-existing WiFi network. However, if no such network exists, then a wireless access point can be provided for the cameras of the security system 5, so that their images can be transmitted through the internet.

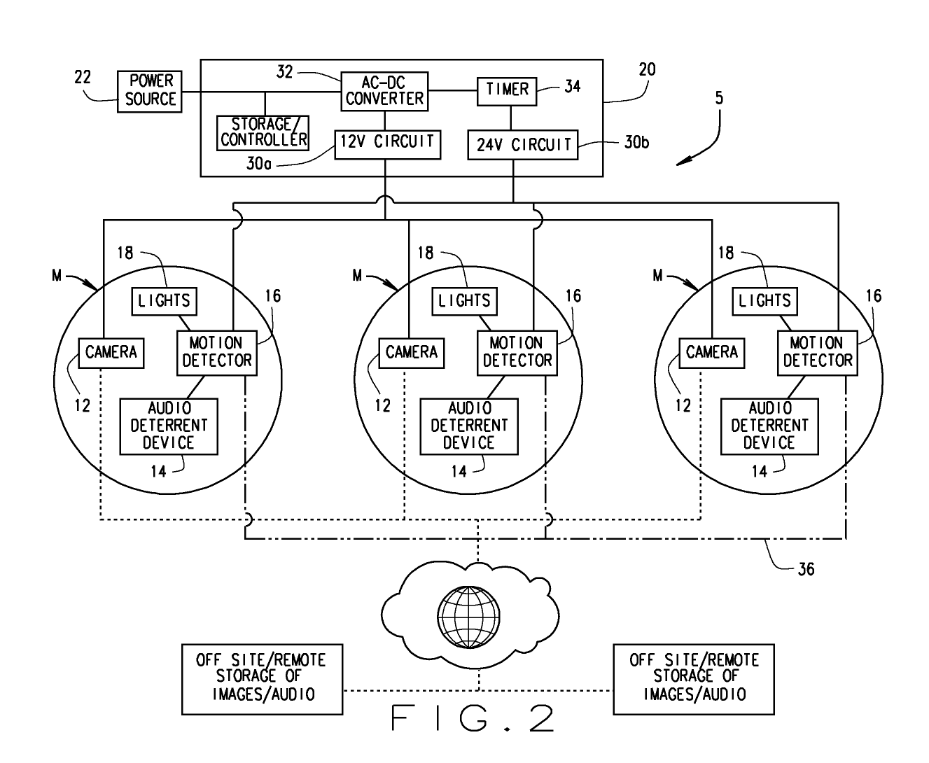

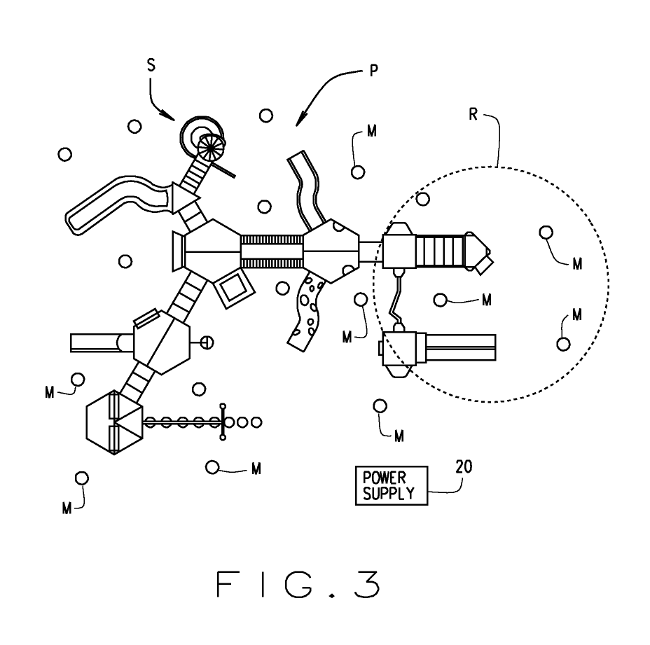

The 24V circuit, as noted above, is “live” only when it is sufficiently dark, as detected by the dusk-to-dawn sensor. When the 24V circuit is live, the lights 18 and audio deterrent device 14 are activated when the motion detector 16 detects motion in the vicinity of the post 10. When motion is detected, the motion sensor 16 will activate the lights 18 and audio deterrent device 14 for a predetermined amount of time. For example, the lights 18 and audio deterrent device 14 could be activated for 10-15 minutes. The motion detector can include a timer, or a separate timer can be provided. A shorter or greater time could be used, as desired. It is to be noted, that there is a motion detector 16 for each monitoring station. Hence, the motion detector for a specific post will only activate the lights 18 and audio deterrent device for that monitoring station. Activation of the components of one monitoring station does not activate the components of another monitoring station. However, the security system 5 can be controlled such that the detection of motion by the motion detector 16 of one monitoring station can activate the lights and audio deterrent devices of all the monitoring stations M of the security system, or a set of monitoring stations M within a certain radius R of the monitoring station where motion was detected. For example, the motion detectors of a set of monitoring stations M could be in communication with each other over a line 36, as shown in FIG. 2, whereby, when the motion detector of one monitoring station is activated, it sends a signal to the motion detectors of other monitoring stations with which it communicates over the line 36, to activate the lights and audio deterrent devices of the adjacent monitoring stations M. This would illuminate a greater area of the playground and broadcast the deterrent sound to a greater area of the playground.

Although not shown in the drawings, the monitoring stations M could also be provided with “panic button” devices, which when activated notify emergency personnel that help is needed at the specific location. For a unitary monitoring station, the panic button would be located on the post 10. However, for a multi-part monitoring station, the panic button can be associated with any of the housings of the monitoring station (i.e., the light assembly 18′, or the housing containing the camera and audio deterrent device). For example, the panic button device could send a pre-programmed message vie email, telephone, cell phone or police band radio to emergency personnel. One such device is available from StopTech, Ltd of Harrison, Ohio under the name Centurion.

As various changes could be made in the above constructions without departing from the scope of the invention, it is intended that all matter contained in the above description or shown in the accompanying drawings shall be interpreted as illustrative and not in a limiting sense. For example, although the components are shown and described as being mounted in a playground post, the components could also be mounted in a playground cover, such as a roof component of a playground play system. In a multi-part monitoring station, the light assemblies 18′ can be positioned about a desired portion of the playground, and the camera and audio deterrent device can be located together or separately on the play system. In addition, the dawn-to-dusk sensor or timer could be interposed between the power source and the 12V circuit, such that the camera 12 is powered only when it is sufficiently dark. Alternatively, only the lights could be controlled by the dawn-to-dusk sensor or timer. FIG. 2 shows 3 monitoring stations. However, a playground could be provided with additional monitoring stations. Although the two circuits are shown as 12V and 24V circuits, the voltage is determined by the equipment on the circuit. The circuits could be of different voltages (i.e., other than 12V and 24V); further, both circuits could be the same voltage (whether that voltage is 12V, 24V or some other voltage). In this latter case, one circuit would be an “always on” circuit, and the other circuit would be activated by the timer 34. Further, although the circuits are described to be DC circuits, the circuits could be AC circuits. In either case, the voltage of the two circuits can be a broad range of low voltages (from about 3V to about 24V). These examples are merely illustrative.

1. A playground security system comprising a power supply and a monitoring station; the monitoring station comprising a camera, a light and an audio deterrent device; the camera, light and audio deterrent device being electrically connected to the power supply, said camera adapted to transmit signals containing visual or audio-visual information.

2. The playground security system of claim 1 wherein the power supply comprises a timer, a first circuit, and a second circuit; said first circuit being connected to said timer such that said first circuit is controlled by timer; at least one of said components of said monitoring station being in electrical communication with said first circuit.

3. The playground security system of claim 2 wherein said timer is either a dusk-to-dawn sensor or a programmable timer.

4. The playground security system of claim 2 wherein said light and said audio deterrent device are in electrical communication with said first circuit and said camera is in communication with said second circuit.

5. The playground security system of claim 1 wherein the security system is adapted to transmit the camera signal to a location remote from the playground in which the security system is installed for viewing and/or storage of the camera signal.

6. The playground security system of claim 1 wherein the security system comprises a base unit having a computer storage device and a receiver;
the base unit being in communication with the camera to receive signals from the camera; said base unit storing said signals in said storage device.

7. The playground security system of claim 6 wherein the base unit is adapted to transmit the camera signal for viewing and/or storing at a location remote from the playground in which the security system is installed.

8. The playground system of claim 7 wherein the security system is assigned an IP address; said security system being adapted to transmit the signals over the internet.

9. The playground security system of claim 1 wherein said audio deterrent device comprises a sound generator; said sound generator emitting a high frequency modulated tone in the range that is bothersome to people in the between about 13 years old and about 25 years old.

10. The playground security system of claim 9 wherein said sound has a frequency of about 17.5 kHz to about 18.5 kHz at a sound level of about 84-99 db.

11. The playground security system of claim 9 wherein said frequency range of about 17.5 kHz to about 18.5 kHz comprises a first frequency range;
said sound generator being operable at a second frequency range of about 8 kHz;
said sound generator being selectively movable between said first and second frequency ranges.

12. The playground security system of claim 1 wherein said monitoring station includes a motion detector; said motion detector being positioned between the power supply and one or both of said light and said audio deterrent device; said motion detector being operable to activate said light and said audio deterrent device upon sensing motion.

13. The playground security system of claim 12 wherein said playground security system includes a plurality of said monitoring stations; at least a set of said monitoring stations being in communication with each other;
said monitoring stations of said set of monitoring stations being configured to transmit a signal to the remaining monitoring stations of said set of monitoring stations such that when the motion detector of one monitoring station of the set of monitoring stations is activated, at least the light of the remaining monitoring stations of said set of monitoring stations will also be activated.

14. The security system of claim 1 wherein said camera, said audio deterrent device and said light are contained in a single housing.

15. The security system of claim 1 wherein said light is in a housing that is separate from the housing that contains the camera and audio deterrent device.

16. The security system of claim 1, wherein one or more components of said monitoring station are adapted to be incorporated in a playground structure of the playground in which security system is installed.

17. The security system of claim 16 wherein one or more of the components are contained with in a post; said post being adapted to be incorporated in a support post of the playground structure.

18. The security system of claim 1 wherein the monitoring system includes a thermostat and one or both of a heating element and a fan; said thermostat activating said heating element if ambient temperature falls below a predetermined temperature and said thermostat activating said fan if ambient temperature exceeds a predetermined temperature.

19. The security system of claim 18 wherein at least said camera and audio deterrent device are contained in a housing; said housing including upper and lower vents to place the interior of the housing in communication with the exterior of the housing.

20. A playground security system comprising a power supply and a monitoring station; the monitoring station comprising a camera, a light and an audio deterrent device; the camera, light and audio deterrent device being electrically connected to the power supply, said camera adapted to transmit signals containing visual or audio-visual information; the monitoring system comprising a camera housing which contains at least the camera; said housing including a conditioning circuit comprising thermostat, a heater and a fan; said thermostat activating said heater if the ambient temperature falls below a predetermined temperature and said thermostat activating said fan if the ambient temperature exceeds a predetermined temperature.

21. The playground security system of claim 20 wherein said audio deterrent device is contained within said housing.

22. The playground security system of claim 20 wherein the light assembly is contained in a housing separate from said camera housing.

23. The playground security system of claim 20 wherein said camera housing has vent which place an interior of said housing in communication with the exterior of said housing.

24. The playground security system of claim 23 wherein said vent comprises an upper vent positioned vertically above said camera and a lower vent positioned below said camera; said fan being adapted to draw air in through one of said upper and lower vents and to expel air out of the other of the upper and lower vents.
